(19) United States
(12) Patent Application Publication
(10) Pub. No.: US 2026/0171520 A1
(43) Pub. Date: Jun. 18, 2026

(54) BATTERY MANAGEMENT DEVICE

(71) Applicant: TOYOTA JIDOSHA KABUSHIKI KAISHA, Toyota-shi (JP)

(72) Inventors: Hiroki TASHIRO, Nisshin-shi (JP); Yoshiaki KIKUCHI, Toyota-shi (JP); Ryo MANO, Nisshin-shi (JP); Yuji NISHI, Nagoya-shi (JP); Keisuke ISHIKAWA, Nagakute-shi (JP)

(73) Assignee: TOYOTA JIDOSHA KABUSHIKI KAISHA, Toyota-shi (JP)

(21) Appl. No.: 19/403,953

(22) Filed: Nov. 30, 2025

(30) Foreign Application Priority Data
Dec. 16, 2024 (JP) 2024-220221

(51) Int. Cl. H01M 10/42; B60L 50/60; H01M 10/0525

(52) U.S. Cl. CPC H01M 10/425; H01M 10/0525; B60L 50/60; H01M 2010/4271; H01M 2220/20

(57) ABSTRACT

A battery management device includes: an acquisition unit that acquires a degradation evaluation value for evaluating a degree of advance of a high-rate degradation state of a lithium-ion secondary battery; a high-frequency signal supply unit that supplies a high-frequency signal at a frequency of 0.1 MHz or higher to the lithium-ion secondary battery; a detection unit that detects a value of a real part of alternating current impedance from the lithium-ion secondary battery supplied with the high-frequency signal; a calculation unit that calculates an amount of Li deposition in the lithium-ion secondary battery from the detected value of the real part of the alternating current impedance; and a control unit that, as the calculated amount of Li deposition increases, reduces an upper-limit degradation evaluation value for the lithium-ion secondary battery that is a criterion for determining whether the lithium-ion secondary battery is expected to reach the high-rate degradation state.

### CROSS-REFERENCE TO RELATED APPLICATION

This application claims priority to Japanese Patent Application No. 2024-220221 filed on Dec. 16, 2024. The disclosure of the above-identified application, including the specification, drawings, and claims, is incorporated by reference herein in its entirety.

### BACKGROUND

### 1. Technical Field

The present disclosure relates to a battery management device.

### 2. Description of Related Art

There is a demand to suppress deposition of metallic lithium (Li) (hereinafter referred to as “Li deposition”) in lithium-ion secondary batteries to suppress a decrease in performance of the lithium-ion secondary batteries. However, no non-destructive method has been known to detect Li deposition in lithium-ion secondary batteries.

As disclosed in Japanese Patent No. 7347451 (JP 7347451 B), the present inventors developed a technique of detecting a real part of alternating current impedance of a lithium-ion secondary battery using high-frequency signals, and calculating an amount of Li deposition in the lithium-ion secondary battery based on a difference between a current value and an initial value of the real part of the alternating current impedance.

When a lithium-ion secondary battery is charged and discharged continuously at a large current (high-rate current), high-rate degradation such as lithium deposition may occur. The high-rate degradation is a degradation phenomenon in which the internal resistance of a lithium-ion secondary battery increases due in part to unevenness in concentration distribution of lithium ions inside an electrode assembly. An ECU disclosed in Japanese Patent No. 7207343 (JP 7207343 B) calculates a “degradation evaluation value ΣD” for evaluating the degree of advance of high-rate degradation of a lithium-ion secondary battery based on unevenness in concentration distribution of lithium ions. Then, the ECU performs control for suppressing high-rate degradation of the lithium-ion secondary battery (high-rate degradation suppression control) in accordance with the calculated degradation evaluation value ΣD. For example, when the degradation evaluation value ΣD exceeds an upper-limit degradation evaluation value (threshold value TH), the ECU suppresses charging of the lithium-ion secondary battery by reducing allowable charging power (control upper limit value of charging power (charging power upper limit value Win)) for the lithium-ion secondary battery.

### SUMMARY

As the upper-limit degradation evaluation value increases, the charging of the lithium-ion secondary battery is less suppressed, and Li deposition is more likely to advance. From the viewpoint of suppressing Li deposition, the upper-limit degradation evaluation value is set for each type of lithium-ion secondary battery. The rate of advance of Li deposition in lithium-ion secondary batteries varies (e.g., standard deviation σ) among individual products even for the same type of battery. In conventional lithium-ion secondary batteries, for example, in products within a range of ±6σ, the upper-limit degradation evaluation value for each type is set (fixed) excessively low to suppress advance of Li deposition, resulting in a problem of long charging times.

The present disclosure has been made in view of the above problem, and provides a battery management device that can reduce the possibility of a long charging time.

The battery management device according to the present disclosure includes:
an acquisition unit configured to acquire a degradation evaluation value for evaluating a degree of advance of a high-rate degradation state of a lithium-ion secondary battery;
a high-frequency signal supply unit configured to supply a high-frequency signal at a frequency of 0.1 MHz or higher to the lithium-ion secondary battery;
a detection unit configured to detect a value of a real part of alternating current impedance from the lithium-ion secondary battery supplied with the high-frequency signal;
a calculation unit configured to calculate an amount of Li deposition in the lithium-ion secondary battery from the detected value of the real part of the alternating current impedance; and
a control unit configured to, as the calculated amount of Li deposition increases, reduce an upper-limit degradation evaluation value for the lithium-ion secondary battery that is a criterion for determining whether the lithium-ion secondary battery is expected to reach the high-rate degradation state.

In the battery management device described above, the high-frequency signal supply unit may be configured to supply the high-frequency signal of 0.5 MHz or higher to the lithium-ion secondary battery.

In the battery management device described above, the control unit may be configured to limit charging of the lithium-ion secondary battery when the degradation evaluation value for the lithium-ion secondary battery during the charging reaches the upper-limit degradation evaluation value.

In the battery management device described above, the control unit may be configured to control allowable charging power for the lithium-ion secondary battery to decrease and control the upper-limit degradation evaluation value for the lithium-ion secondary battery to decrease as the calculated amount of Li deposition in the lithium-ion secondary battery increases.

In the battery management device described above, the acquisition unit may be configured to acquire the degradation evaluation value for evaluating the degree of advance of the high-rate degradation state of the lithium-ion secondary battery based on behavior of an increase in resistance of the lithium-ion secondary battery that occurs temporarily due to unevenness in concentration distribution of lithium ions inside the lithium-ion secondary battery.

The control unit may be configured to perform control to limit charging of the lithium-ion secondary battery when the control unit detects the behavior of the increase in resistance of the lithium-ion secondary battery that occurs temporarily.

The control unit may be configured to control the upper-limit degradation evaluation value to decrease as the calculated amount of Li deposition in the lithium-ion secondary battery increases.

According to the present disclosure, the possibility of a long charging time can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of the configuration of a battery management device according to a first embodiment;

FIG. 2 is a diagram showing a relationship between a state of health (SOH) of a secondary battery and an amount of change in a real part Z of alternating current impedance when a high-frequency signal of 1 MHz is supplied to the secondary battery;

FIG. 3 is a diagram showing a relationship between the frequency of an alternating current signal supplied to the secondary battery and the real part of the alternating current impedance detected from the secondary battery;

FIG. 4 is a diagram showing a relationship between the frequency of the alternating current signal supplied to the secondary battery and the real part of the alternating current impedance detected from the secondary battery;

FIG. 5 is a flowchart showing a battery management method according to the first embodiment; and

FIG. 6 is a block diagram showing an example of the configuration of a battery management system according to a second embodiment.

### DETAILED DESCRIPTION OF EMBODIMENTS

Specific embodiments to which the present disclosure is applied will be described in detail below with reference to the drawings. However, the present disclosure is not limited to the following embodiments. The following description and drawings are simplified as appropriate for clarity of description.

### First Embodiment

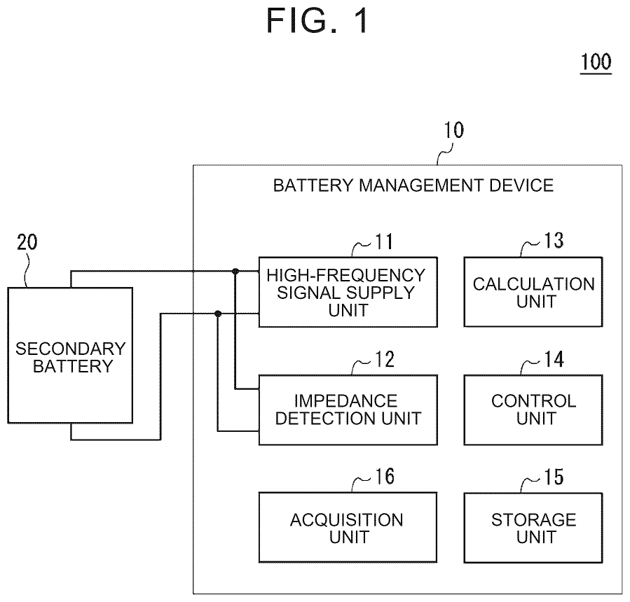

FIG. 1 is a block diagram showing an example of the configuration of a battery management system according to a first embodiment. As shown in FIG. 1, a battery management system 100 includes a battery management device 10 and a secondary battery 20 managed by the battery management device 10.

### Configuration of Secondary Battery 20

First, the secondary battery 20 to be managed will be described.

The secondary battery 20 is a lithium-ion secondary battery, and includes a cell stack composed of a plurality of stacked battery cells, and a case that houses the cell stack. Each of the battery cells includes a cathode, an anode, and an ionic transmission medium that is provided between the cathode and the anode, and that conducts carrier ions. A separator may further be provided between the cathode and the anode. The separator is made of a resin such as polyethylene or polypropylene.

A cathode active material is, for example, a sulfide containing a transition metal element, or an oxide containing lithium and a transition metal element. Specifically, the cathode active material is a lithium manganese composite oxide with a basic composition formula such as Li₍₁₋ₓ₎MnO₂ (where 0<x<1) or Li₍₁₋ₓ₎Mn₂O₄, a lithium cobalt composite oxide with a basic composition formula such as Li₍₁₋ₓ₎CoO₂, a lithium nickel composite oxide with a basic composition formula such as Li₍₁₋ₓ₎NiO₂, a lithium nickel cobalt manganese composite oxide with a basic composition formula such as Li₍₁₋ₓ₎NiₐCo_{b}Mn_{c}O₂ (where a+b+c=1), etc. The cathode active material may be a substance with the above basic composition formula containing other elements. A current collector of the cathode is, for example, aluminum (Al).

An anode active material is, for example, a composite oxide containing lithium, or a carbon material. Specifically, the anode active material is an inorganic compound such as lithium, a lithium alloy, or a tin compound, a carbon material that can store and release lithium ions, a composite oxide containing a plurality of elements, or a conductive polymer. Examples of the carbon material to be used for the anode active material include cokes, glassy carbons, graphites, non-graphitizable carbons, pyrolytic carbons, and carbon fibers. Graphites such as artificial graphite and natural graphite are preferable. Examples of the composite oxide to be used for the anode active material include lithium titanium composite oxides and lithium vanadium composite oxides. A current collector of the anode is, for example, copper (Cu).

An ionically conductive medium is used as an electrolytic solution, for example, by dissolving a supporting salt. The supporting salt is a lithium salt such as LiPF₆ or LiBF₄. A solvent for the electrolytic solution is, for example, any one of carbonates, esters, ethers, nitriles, furans, sulfolanes, and dioxolanes, or a mixture of several of these. Examples of the carbonates include cyclic carbonates such as ethylene carbonate, propylene carbonate, vinylene carbonate, butylene carbonate, and chloroethylene carbonate, and chain carbonates such as dimethyl carbonate, ethyl methyl carbonate, diethyl carbonate, ethyl-n-butyl carbonate, methyl-t-butyl carbonate, di-i-propyl carbonate, and t-butyl-i-propyl carbonate. Alternatively, the ionically conductive medium may be a solid ionically conductive polymer, an inorganic solid electrolyte, a mixed material of an organic polymer electrolyte and an inorganic solid electrolyte, or an inorganic solid powder that is bound by an organic binder.

In the secondary battery 20, metallic Li is deposited on electrode surfaces of the battery cells as a result of repeated charging. Li deposition advances more as the charging power is increased to increase the charging rate, and causes degradation of the state of health (SOH) of the secondary battery 20.

The SOH of the secondary battery 20 refers to the percentage of the current fully charged capacity of the secondary battery 20 when the initial fully charged capacity is 100%. Therefore, there is a demand to control high-rate charging and discharging of the secondary battery 20 while suppressing Li deposition in the secondary battery 20.

### Configuration of Battery Management Device 10

Next, the battery management device 10 that manages the secondary battery 20 will be described.

As shown in FIG. 1, the battery management device 10 includes a high-frequency signal supply unit 11, an impedance detection unit 12, a calculation unit 13, a control unit 14, a storage unit 15, and an acquisition unit 16, and manages the charging of the secondary battery 20 to be managed. The battery management device 10 calculates the amount of Li deposition in the secondary battery 20, and performs feedback control on an upper-limit degradation evaluation value for the secondary battery 20 based on the calculation result. The upper-limit degradation evaluation value for the secondary battery 20 is a criterion for determining whether the secondary battery 20 may reach a high-rate degradation state.

The battery management device 10 includes, as hardware, an arithmetic unit (not shown) such as a central processing unit (CPU) in addition to the storage unit 15 such as a random access memory (RAM) or a read only memory (ROM) that stores various programs and data. That is, the battery management device 10 has functions of a computer and performs various processes based on the various programs etc.

Therefore, the functional blocks of the high-frequency signal supply unit 11, the impedance detection unit 12, the calculation unit 13, the control unit 14, the storage unit 15, and the acquisition unit 16 that constitute the battery management device 10 in FIG. 1 can be configured in terms of hardware by the central processing unit (CPU), the memory, and other circuits, and can be implemented in terms of software by the programs loaded into the memory, etc. That is, each of the functional blocks can be implemented in various forms using computer hardware, software, or a combination thereof.

The high-frequency signal supply unit 11 supplies a high-frequency signal for detecting the amount of Li deposition to the secondary battery 20. Specifically, the high-frequency signal supply unit 11 supplies a high-frequency signal of 0.1 MHz or higher to the secondary battery 20. The high-frequency signal is preferably a high-frequency signal for detecting a value of a real part of alternating current impedance that is 10 times or more, due to the skin effect, as large as a value of a real part Z of the alternating current impedance detected when an alternating current signal of 1 kHz is supplied to the secondary battery 20. Specifically, the frequency of the high-frequency signal is preferably 0.5 MHz or higher.

When the high-frequency signal having such a frequency is supplied to the secondary battery 20, the diffusion, reaction, and movement of lithium ions in each battery cell of the secondary battery 20 cannot keep up. Therefore, the current of the high-frequency signal flows, due to the skin effect, over the electrode surfaces of each battery cell where Li deposition is likely to occur.

When the SOH degrades without occurrence of Li deposition from the initial state, that is, the state in which the amount of Li deposition is substantially 0 (zero), the real part Z of the alternating current impedance does not change. When Li is deposited, the real part Z of the alternating current impedance decreases. As the amount of Li deposition increases, the electrical conductivity of the electrode surfaces of each battery cell increases. Therefore, the value of the real part Z of the alternating current impedance decreases. A large amount of current is concentrated on the Li metal having high electrical conductivity. Accordingly, the magnetic field changes around Li deposition regions, and eddy currents are generated. Such eddy currents cause loss in conductive portions of current collecting foils and electrodes, but reduce loss in the battery as a whole. As the amount of Li deposition increases, the change in the magnetic field increases, and accordingly the eddy currents increase. Thus, the value of the real part Z decreases. Therefore, the amount of Li deposition in the secondary battery 20 can be calculated from the amount of change in the real part Z of the alternating current impedance (difference between the detected value and the initial value) detected from the secondary battery 20 supplied with the high-frequency signal. Further, the SOH of the secondary battery 20 can be estimated based on the amount of Li deposition.

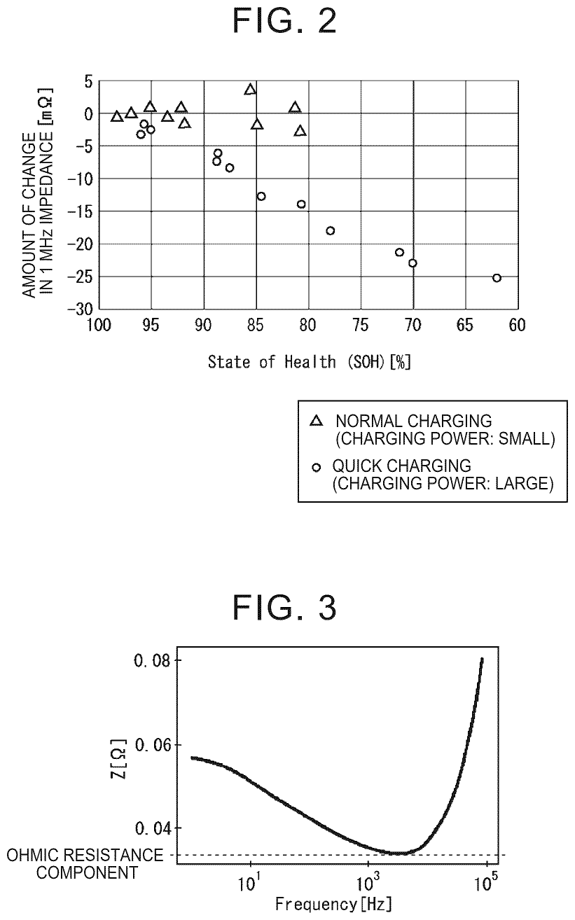

FIG. 2 is a graph showing a relationship between the SOH of the secondary battery 20 and the amount of change in the real part Z of the alternating current impedance (difference between the detected value and the initial value) when a high-frequency signal of 1 MHz is supplied to the secondary battery 20.

As indicated by triangle marks in FIG. 2, in the case of normal charging with small charging power, the amount of Li deposition is small even when charging is repeated, and accordingly the amount of change in the real part Z of the alternating current impedance remains small even when degradation of the SOH advances due to some other factor. That is, the detected value of the real part Z of the alternating current impedance is maintained at a high value.

As indicated by circle marks in FIG. 2, in the case of quick charging with large charging power, the amount of Li deposition increases with repeated charging, and accordingly the degradation of the SOH advances and the amount of change in the real part Z of the alternating current impedance increases. That is, the detected value of the real part Z of the alternating current impedance is low. When Li deposition is predominant among causes of the battery degradation, the amount of Li deposition can be derived from the SOH. Alternatively, the SOH can be derived from the amount of Li deposition.

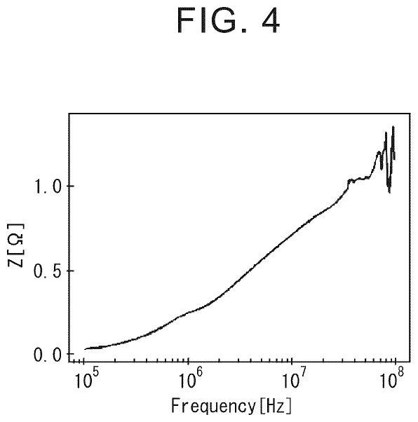

FIGS. 3 and 4 are graphs showing a relationship between the frequency of the alternating current signal supplied to the secondary battery 20 and the real part of the alternating current impedance detected from the secondary battery 20. FIG. 3 shows the value of the real part Z of the alternating current impedance when alternating current signals ranging from 1 kHz to 100 kHz are supplied to the secondary battery 20. FIG. 4 shows the value of the real part Z of the alternating current impedance when alternating current signals ranging from 100 kHz to 100 MHz are supplied to the secondary battery 20.

As shown in FIG. 3, when an alternating current signal of around 1 kHz is supplied to the secondary battery 20, the value of the real part Z of the alternating current impedance is a minimum value. This impedance component is an ohmic resistance component. As shown in FIGS. 3 and 4, as the frequency of the alternating current signal supplied to the secondary battery 20 increases, the skin effect causes the current flow to concentrate on the electrode surface of each cell, and accordingly the value of the real part Z of the alternating current impedance increases.

Therefore, the high-frequency signal supply unit 11 supplies the secondary battery 20 with an alternating current signal (i.e., a high-frequency signal) having a high frequency for detecting a value of the real part Z of the alternating current impedance that is sufficiently higher than the ohmic resistance component.

The impedance detection unit 12 detects the value of the real part Z of the alternating current impedance from the secondary battery 20 supplied with the high-frequency signal. As described above, the current of the high-frequency signal supplied from the high-frequency signal supply unit 11 to the secondary battery 20 flows over the electrode surface (Li deposition region) of each battery cell of the secondary battery 20 due to the skin effect. Even when the Li metal is electrically disconnected from the anode after Li deposition and is in a floating state, the current still flows over the Li metal due to inductive coupling and capacitive coupling. Thus, the impedance detection unit 12 can detect the real part Z of the alternating current impedance in accordance with the amount of Li deposition.

The calculation unit 13 calculates the amount of Li deposition in the secondary battery 20 based on a difference between the current value of the real part Z of the alternating current impedance detected by the impedance detection unit 12 and the initial value of the real part Z of the alternating current impedance of the secondary battery 20. Specifically, the calculation unit 13 calculates a smaller value of the amount of Li deposition as the detected value of the real part Z of the alternating current impedance increases and the difference between the detected value and the initial value decreases. The calculation unit 13 calculates a larger value of the amount of Li deposition as the detected value of the real part Z of the alternating current impedance decreases and the difference between the detected value and the initial value increases.

For example, the storage unit 15 stores the initial value of the real part Z of the alternating current impedance of the secondary battery 20 to be managed. Alternately, the storage unit 15 may store map information that represents a relationship between a difference (amount of change) between the current value (detected value) and the initial value of the real part Z of the alternating current impedance of each type of secondary battery and the amount of Li deposition.

This map information is, for example, information obtained through experimentation in advance, but may be updated as appropriate based on information detected from the secondary battery 20 to be managed. When using the map information, the calculation unit 13 extracts the amount of Li deposition corresponding to the value of the real part Z of the alternating current impedance detected by the impedance detection unit 12 from the map information stored in the storage unit 15.

The acquisition unit 16 acquires a degradation evaluation value ΣD for evaluating the degree of advance of the high-rate degradation state of the secondary battery 20. The acquisition unit 16 can acquire the degradation evaluation value ΣD by calculating it using the voltage, current, and temperature of the secondary battery 20. The acquisition unit 16 may include sensors that detect the voltage, current, and temperature of the secondary battery 20. The acquisition unit 16 may acquire the voltage, current, and temperature of the secondary battery 20 from an integrated electronic control unit (ECU) or a battery ECU via an in-vehicle network. The acquisition unit 16 may acquire the temperature of the secondary battery 20 from a thermistor. Specifically, the acquisition unit 16 may acquire the degradation evaluation value for evaluating the degree of advance of the high-rate degradation state of the secondary battery 20 based on the behavior of an increase in resistance of the secondary battery 20 that occurs temporarily due to unevenness in concentration distribution of lithium ions inside the secondary battery 20.

The control unit 14 performs control for suppressing high-rate degradation of the secondary battery 20 (high-rate degradation suppression control) in accordance with the degradation evaluation value ΣD acquired by the acquisition unit 16. When the degradation evaluation value ΣD exceeds the upper-limit degradation evaluation value for the secondary battery 20, the control unit 14 reduces the allowable charging power for the secondary battery 20.

Thus, the battery management device 10 according to the present disclosure can set the highest possible upper-limit degradation evaluation value for the secondary battery 20 to enable efficient charging in the shortest possible charging time while suppressing Li deposition. That is, the battery management device 10 according to the present disclosure can set the upper-limit degradation evaluation value for the secondary battery 20 to an appropriate value depending on the amount of Li deposition without setting it to an excessively low value. Therefore, the possibility of a long charging time can be reduced. Further, the secondary battery 20 can be charged efficiently.

### Battery Management Method

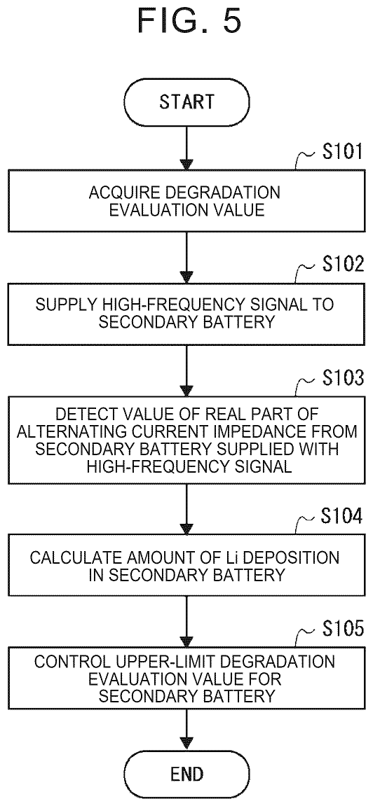

Next, a battery management method according to the present embodiment, that is, an operation of the battery management device 10, will be described with reference to FIG. 5. FIG. 5 is a flowchart showing the battery management method according to the first embodiment.

First, the battery management device 10 acquires the degradation evaluation value ΣD (step S101). For example, the battery management device 10 detects the voltage, current, and temperature of the secondary battery 20, and acquires the degradation evaluation value ΣD by calculating it using the detected voltage, current, and temperature.

Next, the battery management device 10 supplies the secondary battery 20 with an alternating current signal (high-frequency signal) having such a high frequency that the diffusion, reaction, and movement of lithium ions in each battery cell cannot keep up (step S102). For example, the high-frequency signal supply unit 11 supplies a high-frequency signal of 0.1 MHz or higher to the secondary battery 20.

Next, the battery management device 10 detects the value of the real part Z of the alternating current impedance from the secondary battery 20 supplied with the high-frequency signal (step S103).

Next, the battery management device 10 calculates the amount of Li deposition in the secondary battery 20 from the detected value of the real part Z of the alternating current impedance (step S104). For example, the battery management device 10 extracts the amount of Li deposition corresponding to the detected value of the real part Z of the alternating current impedance from the map information stored in the storage unit 15. Basically, the battery management device 10 calculates a smaller value of the amount of Li deposition as the detected value of the real part Z of the alternating current impedance increases, and calculates a larger value of the amount of Li deposition as the detected value of the real part Z of the alternating current impedance decreases.

Finally, the battery management device 10 controls the upper-limit degradation evaluation value for the secondary battery 20 based on the calculated amount of Li deposition (step S105). For example, when the calculated amount of Li deposition is small, the advance of Li deposition is being suppressed, and accordingly the battery management device 10 controls the upper-limit degradation evaluation value to maintain the current level or to be higher. As the calculated amount of Li deposition increases, it is more necessary to suppress the advance of Li deposition, and accordingly the battery management device 10 controls the upper-limit degradation evaluation value for the secondary battery 20 to decrease.

As described above, the battery management device 10 according to the present disclosure can set the highest possible upper-limit degradation evaluation value for the secondary battery 20 to enable efficient charging in the shortest possible charging time while suppressing Li deposition. That is, the battery management device 10 according to the present disclosure can set the upper-limit degradation evaluation value for the secondary battery 20 to an appropriate value depending on the amount of Li deposition without setting it to an excessively low value. Therefore, the possibility of a long charging time can be reduced. Further, the secondary battery 20 can be charged efficiently.

The control unit 14 controls the upper-limit degradation evaluation value for the secondary battery 20 based on the amount of Li deposition calculated by the calculation unit 13. Specifically, as the amount of Li deposition calculated by the calculation unit 13 increases, it is more necessary to suppress the advance of Li deposition, and accordingly the control unit 14 controls the upper-limit degradation evaluation value for the secondary battery 20 to decrease. Therefore, when the upper-limit degradation evaluation value for the secondary battery 20 decreases, the degradation evaluation value ΣD easily exceeds the upper-limit degradation evaluation value for the secondary battery 20. Thus, the control unit 14 reduces the allowable charging power for the secondary battery 20. Accordingly, high-rate charging and discharging of the secondary battery 20 can be suppressed. As a result, Li deposition in the secondary battery 20 can be suppressed.

The control unit 14 may limit the charging of the secondary battery 20 when the degradation evaluation value ΣD for the secondary battery 20 during charging reaches the upper-limit degradation evaluation value. Specifically, the control unit 14 may stop the charging of the secondary battery 20. Therefore, the charging of the lithium-ion secondary battery that may reach the high-rate state can be stopped, and the lithium-ion secondary battery can be protected from high-rate degradation.

The control unit 14 may control the allowable charging power for the secondary battery 20 to decrease and control the upper-limit degradation evaluation value for the secondary battery 20 to decrease as the amount of Li deposition calculated by the calculation unit 13 increases. Therefore, it is possible to control the allowable charging power and the upper-limit degradation evaluation value in accordance with the increase in the amount of Li deposition, thereby strengthening the protection against high-rate degradation.

In the present embodiment, the acquisition unit 16 acquires the degradation evaluation value for evaluating the degree of advance of the high-rate degradation state of the secondary battery 20 based on the behavior of an increase in resistance of the secondary battery 20 that occurs temporarily due to unevenness in concentration distribution of lithium ions inside the secondary battery 20. When the control unit 14 detects the behavior of the increase in resistance of the secondary battery 20 that occurs temporarily, the control unit 14 performs control to limit the charging of the secondary battery 20, and controls the upper-limit degradation evaluation value to decrease as the amount of Li deposition calculated by the calculation unit 13 increases. Therefore, the charging of the lithium-ion secondary battery that may reach the high-rate state along with the short-term increase in resistance can be limited, thereby strengthening the protection against high-rate degradation.

### Second Embodiment

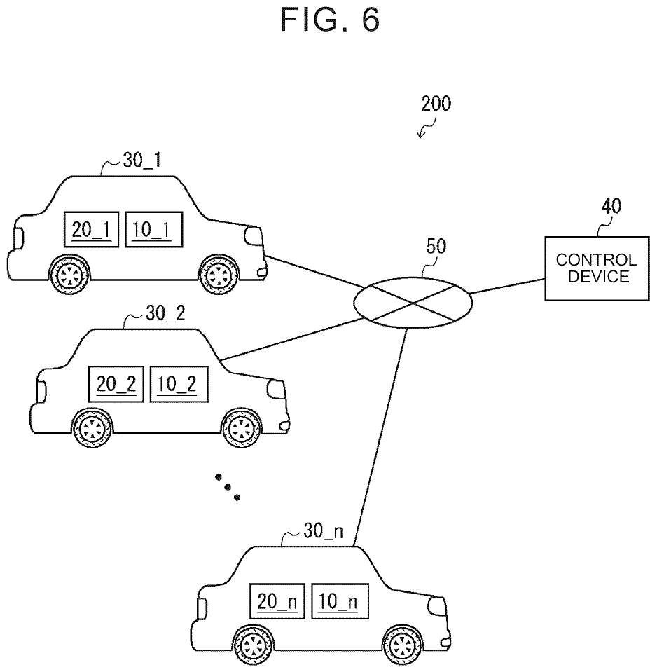

FIG. 6 is a block diagram showing an example of the configuration of a battery management system 200 according to a second embodiment. The battery management system 200 includes n (n is an integer of 2 or more) battery management devices 10 provided in association with n secondary batteries 20, a control device 40, and a network 50. The n battery management devices 10 and the control device 40 are configured to communicate with each other via the network 50. Hereinafter, the n secondary batteries 20 will also be referred to as “secondary batteries 20_1 to 20_n” and the n battery management devices 10 will also be referred to as “battery management devices 10_1 to 10_n.”

The secondary batteries 20_1 to 20_n are mounted on vehicles 30_1 to 30_n, respectively. The battery management devices 10_1 to 10_n are mounted on the vehicles 30_1 to 30_n together with the secondary batteries 20_1 to 20_n, respectively. All of the vehicles 30_1 to 30_n are battery electric vehicles or hybrid electric vehicles powered by the secondary batteries.

The control device 40 switches details of control on the upper-limit degradation evaluation values for the secondary batteries 20_1 to 20_n managed by the battery management devices 10_1 to 10_n, respectively, depending on the statuses of limitation on the upper-limit degradation evaluation values set for the secondary batteries 20_1 to 20_n. Specifically, the control device 40 learns details of setting of the upper-limit degradation evaluation values for the secondary batteries 20_1 to 20_n managed by the battery management devices 10_1 to 10_n, respectively, and updates the details of setting of the upper-limit degradation evaluation values for the secondary batteries 20_1 to 20_n based on the learning results. In other words, the control device 40 updates the details of setting of the upper-limit degradation evaluation values for the secondary batteries 20_1 to 20_n using a trained model generated by machine learning using the details of setting of the upper-limit degradation evaluation values.

For example, when upper-limit degradation evaluation values lower than expected are set for a predetermined number or more of secondary batteries 20 managed by a predetermined number or more of battery management devices 10 among the battery management devices 10_1 to 10_n after a predetermined period of use has elapsed, the initial values of the upper-limit degradation evaluation values may be excessively high. In such a case, the control device 40 controls the upper-limit degradation evaluation values to decrease for all of the secondary batteries 20_1 to 20_n managed by the battery management devices 10_1 to 10_n, respectively. This suppresses the advance of Li deposition in each of the secondary batteries 20_1 to 20_n. The control device 40 may set the initial value of the upper-limit degradation evaluation value for a newly shipped secondary battery 20 to a low value as in the case of the secondary batteries 20_1 to 20_n.

The present disclosure is not limited to the above embodiments, and can be modified as appropriate without departing from the spirit and scope of the present disclosure. The present disclosure may be implemented by combining the above embodiments and examples thereof as appropriate.

What is claimed is:

1. A battery management device comprising:
an acquisition unit configured to acquire a degradation evaluation value for evaluating a degree of advance of a high-rate degradation state of a lithium-ion secondary battery;
a high-frequency signal supply unit configured to supply a high-frequency signal at a frequency of 0.1 MHz or higher to the lithium-ion secondary battery;
a detection unit configured to detect a value of a real part of alternating current impedance from the lithium-ion secondary battery supplied with the high-frequency signal;
a calculation unit configured to calculate an amount of Li deposition in the lithium-ion secondary battery from the detected value of the real part of the alternating current impedance; and
a control unit configured to, as the calculated amount of Li deposition increases, reduce an upper-limit degradation evaluation value for the lithium-ion secondary battery that is a criterion for determining whether the lithium-ion secondary battery is expected to reach the high-rate degradation state.

2. The battery management device according to claim 1, wherein the high-frequency signal supply unit is configured to supply the high-frequency signal of 0.5 MHz or higher to the lithium-ion secondary battery.

3. The battery management device according to claim 1, wherein the control unit is configured to limit charging of the lithium-ion secondary battery when the degradation evaluation value for the lithium-ion secondary battery during the charging reaches the upper-limit degradation evaluation value.

4. The battery management device according to claim 1, wherein the control unit is configured to control allowable charging power for the lithium-ion secondary battery to decrease and control the upper-limit degradation evaluation value for the lithium-ion secondary battery to decrease as the calculated amount of Li deposition in the lithium-ion secondary battery increases.

5. The battery management device according to claim 1, wherein:
the acquisition unit is configured to acquire the degradation evaluation value for evaluating the degree of advance of the high-rate degradation state of the lithium-ion secondary battery based on behavior of an increase in resistance of the lithium-ion secondary battery that occurs temporarily due to unevenness in concentration distribution of lithium ions inside the lithium-ion secondary battery;
the control unit is configured to perform control to limit charging of the lithium-ion secondary battery when the control unit detects the behavior of the increase in resistance of the lithium-ion secondary battery that occurs temporarily; and
the control unit is configured to control the upper-limit degradation evaluation value to decrease as the calculated amount of Li deposition in the lithium-ion secondary battery increases.
